(19) United States
(12) Patent Application Publication
(10) Pub. No.: US 2011/0036111 A1
(43) Pub. Date: Feb. 17, 2011

(54) LOW PROFILE REFRIGERATION SYSTEM

(75) Inventors: Joaquim Ferreira, Freneuse (FR); Claude Saudoyez, Vieux Manoir (FR); Veronique Michel, Chaponost (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: Carrier Corporation, Farmington, CT (US)

(21) Appl. No.: 12/867,072

(22) PCT Filed: Feb. 12, 2008
(86) PCT No.: PCT/US08/53650

§ 371 Date: Oct. 8, 2010

(51) Int. Cl. B60H 1/32; F25D 17/06

(52) U.S. Cl. 62/239; 62/507

(57) ABSTRACT

A self-contained vehicle refrigeration console includes an interior section mounted below the vehicle roof and including evaporator and compressor sections, and an exterior section mounted on the outer surface of the roof and supporting the condenser fan but providing a low vertical profile. The roof has two openings formed therein, one being adapted to receive a condenser coil therein and the other being located below the condenser fan. The condenser fan causes ambient air to flow under the exterior section, through said one opening and condenser coil, under the vehicle roof, and out the other opening to the ambient.

### TECHNICAL FIELD

This invention relates generally to transport refrigeration systems, and more particularly, to a refrigeration console which is adapted for use with small vehicles.

### BACKGROUND OF THE INVENTION

Transport refrigeration systems are commonly used for truck/trailer installations as well as refrigerated containers. Generally, such a transport refrigeration system is a relatively large, self-contained unit which is attached to the front side of a trailer or container, with the evaporator section thereof fluidly communicating with the internal confines of the trailer/container.

A self-contained unit normally includes the compressor of the refrigeration system and is likely to include a generator and a diesel engine for driving the generator. Such a system is too large for use on smaller trucks. Instead, the condenser and evaporator coils are mounted on the truck, with the condenser being visibly mounted on the front side thereof, and the evaporator section being inserted into the interior of the truck. The compressor is mounted near the drive engine of the vehicle and is mechanically connected thereto such that the vehicle engine drives the compressor. Since the compressor is a component of the refrigerant circuit within the system, it is then necessary to provide for fluid communication between the evaporator and the compressor and between the compressor and the condenser, such that the refrigerant can circulate through the circuit. The conduits can, of course be thermally insulated to limit the amount of heat transferred thereto, but some heat will be transferred to the refrigerant, thereby resulting in efficiency losses. Further, the refrigerant lines, in addition to being an added expense, are susceptible to being damaged, in which case, the refrigerant may be lost.

Where it has been desired to refrigerate small vans, the installation has been similar to that of trucks in that the compressor is driven by the van drive engine, and refrigerant lines are routed to the condenser/evaporator unit. However, rather than being mounted on the front of the vehicle as in the case of a truck, it is necessary to mount it on the top of the van. Such an installation is undesirable for several reasons. First, the condenser unit is generally relatively large and presents a large profile which increases wind resistance and fuel usage. Secondly, it adds significantly to the height of the vehicle, thereby limiting access of vehicle to some bridges and other structures and increases the likelihood of damage to the unit. Finally, the unit is generally not pleasing to the eye.

### DISCLOSURE OF THE INVENTION

In accordance with one aspect of the invention, the exterior section of a console includes a condenser coil mounted in one opening of the roof and a motor driven condenser fan is mounted above another opening in the roof. The condenser fan causes the ambient air to flow downwardly through the first opening and the condenser coil, through a space under the roof, and upwardly through a second opening to ambient. A low profile platform is disposed above the roof, and the condenser fan and its drive motor is supportively connected thereto.

In accordance with another aspect of the invention, the interior section of the console includes an insulated housing with bottom and side walls with upper edges of the side walls being mounted adjacent the inner surface of the vehicle roof, the housing containing a frame, a compressor and electric drive motor as well as an evaporator fan, fan and drive motor, and the housing further having a return air opening and a supply air opening such that the evaporator fan causes air to be drawn from an interior space in the vehicle, pass through the evaporator coil and return to the vehicle interior by way of the supply air opening.

In the drawings as hereinafter described, a preferred embodiment is depicted; however, various other modifications and alternate constructions can be made thereto without departing from the spirit and scope of the invention.

### BRIEF DESCRIPTION OF THE DRAWINGS

FIG. 1 is a side view of the present invention as installed in a vehicle.

FIG. 2 is a partial interior view thereof.

FIG. 3 is a partial exterior view thereof.

FIG. 4 is a perspective view of the interior section thereof.

FIG. 5 is a side sectional view thereof.

FIG. 6 is an exploded view of the refrigeration console.

FIG. 7 is a schematic illustration of a rear cut away view of the system as installed in the vehicle.

FIGS. 8 and 9 are respective exploded and side views thereof showing the condenser airflow pattern.

FIG. 10 is a perspective view of the condenser fan and motor.

### DETAILED DESCRIPTION OF THE INVENTION

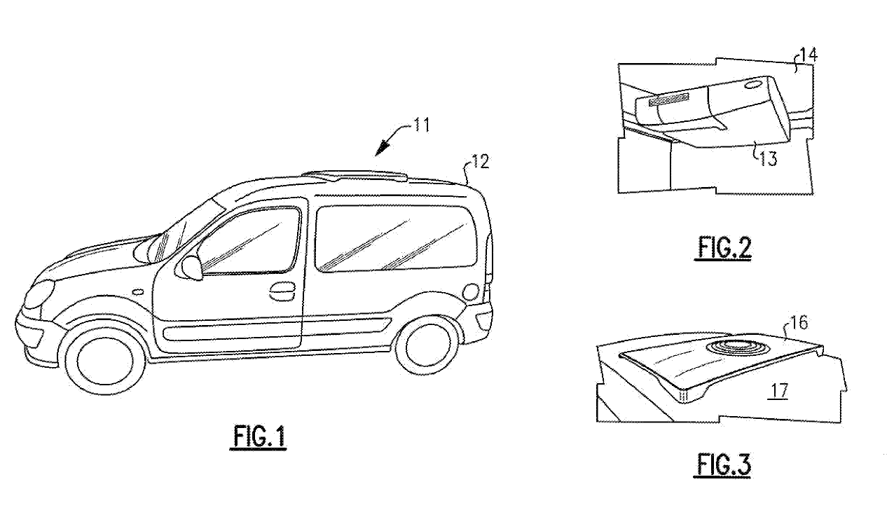

The invention is shown generally at 11 in FIG. 1 as incorporated into a roof of a vehicle 12. The vehicle shown is a small van but it should be understood that the present invention may be used in any other type of vehicle such as a truck or a container.

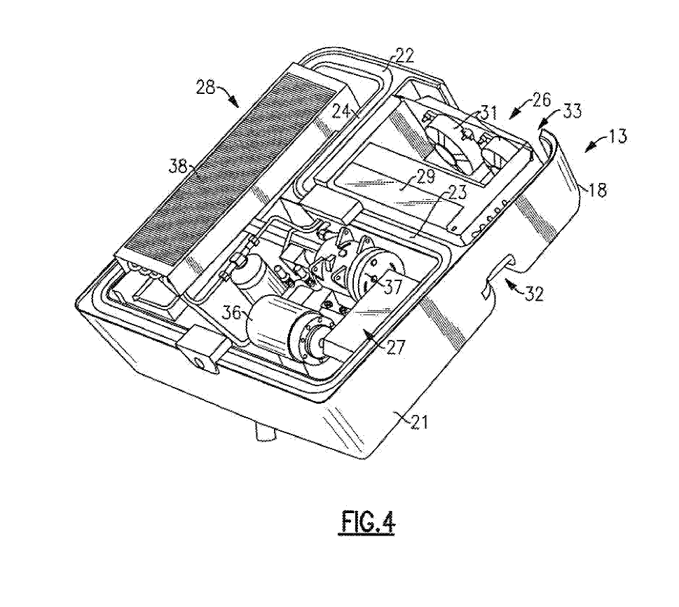

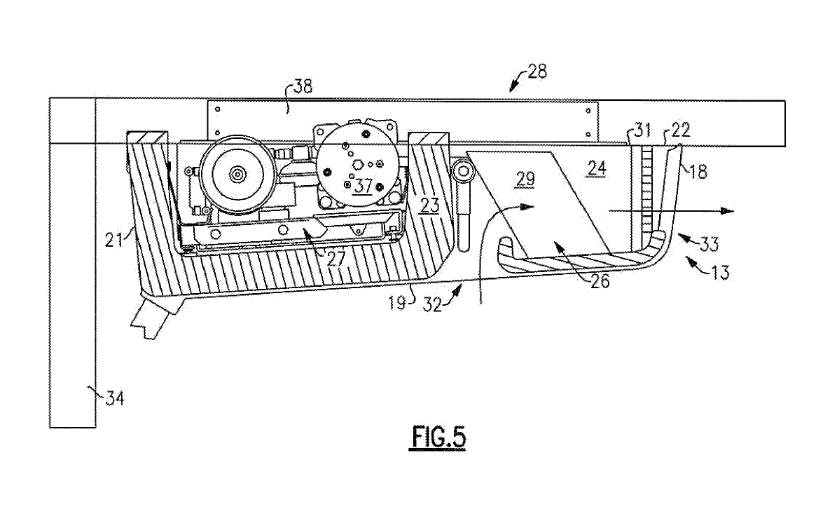

The refrigeration system of the present invention includes an interior portion 13 which is mounted to the underside of the roof 14 as shown in FIG. 2 and an exterior portion 16 which is mounted to the upper side of the roof 17 as shown in FIG. 3. These interior and exterior portions 13 and 16 will be more fully described hereinafter.

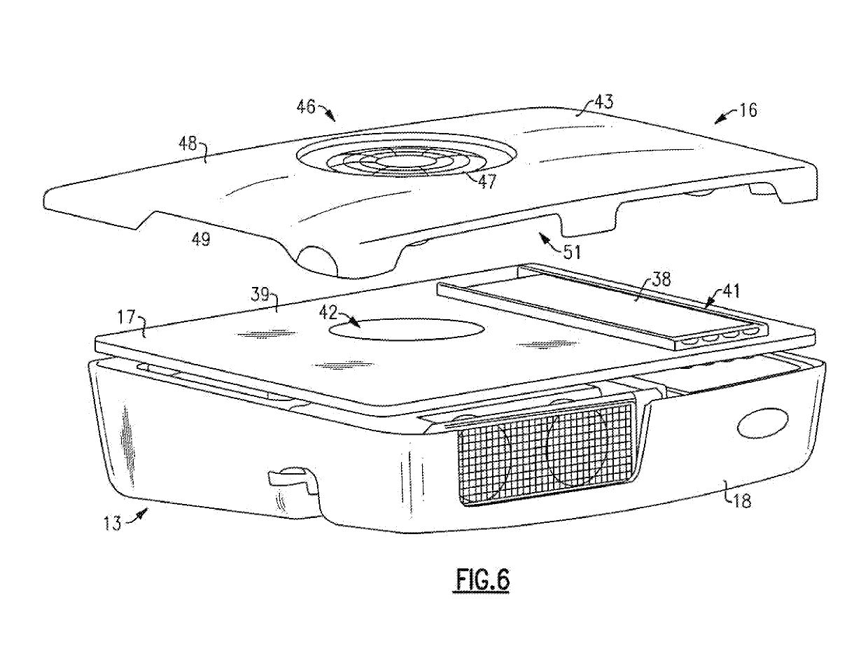

Referring to FIGS. 4 and 5, the refrigeration system interior portion 13 is shown in greater detail to include a housing 18 having a bottom wall 19 and side walls 21 with upper edges 22 which are intended to engage the roof internal surface 14. Housing 18 is formed of a rigid material which is preferably composed of a thermally insulating material such as PEHD & PU.

The housing 18 is divided by upstanding internal walls 23 and 24 into an evaporator section 26, a compressor section 27 and a condenser section 28.

The evaporator section 26 includes an evaporator coil 29 and a pair of evaporator fans 31. A return air opening 32 is formed in the bottom wall 19 and a supply air opening 33 is formed in a side wall of the housing 18 as shown in FIG. 5. In operation, the evaporator fans 31 causes the air from the vehicle insulated box 34 to flow into the return air opening 32, through the evaporator coil 29 to be cooled and out the supply air opening 33 to return to the vehicle insulated box 34.

The compressor section 27 includes a DC motor 36 which is drivingly connected to a compressor 37. The compressor 37 is fluidly interconnected to both the evaporator section 26 and the condenser section 28 so as to provide for the serial flow of refrigerant from the compressor 37 to a condenser coil 38 to an expansion valve (not shown), through the evaporator coil 29 and back to the compressor 37.

The condenser section 28 includes the condenser coil 38 but, rather than being located within the housing 18, the condenser coil 38 is located above the housing 18 as shown in FIGS. 4 and 5 with only the supporting structure therefore being located within the housing 18.

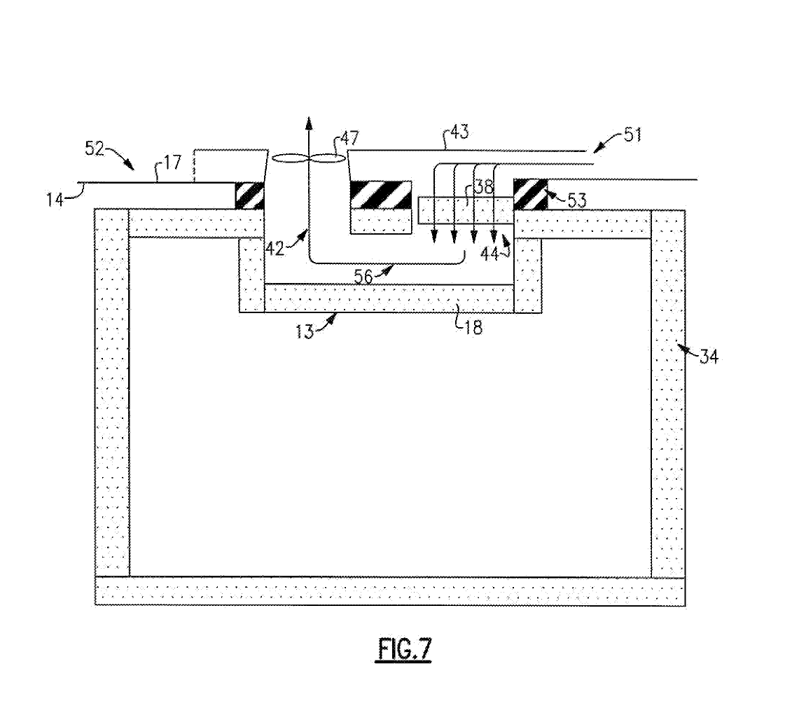

Referring now to FIG. 6, the refrigeration system interior portion 13 is shown as installed on the underside of the vehicle roof 39. The vehicle roof 39 has a pair of opening formed therein. A rectangular opening 41 is formed at a position corresponding to the position of the condenser coil 38 such that, when the interior portion 13 is brought into its installed position, the condenser coil 38 fits into the rectangular opening 41. The other roof opening, which is shown at 42 in FIG. 6, is a round opening which provides for the flow of condenser cooling air to flow to ambient after it has passed through the condenser coil 38 and through a portion of the interior portion 13 in a manner to be described hereinafter.

The exterior portion 16, which is mounted on the roof external surface 17, comprises a low profile platform 43 that includes a generally planar top member 44 with a circular opening 46 therein. A condenser fan 47 is mounted in the opening 46. The top member 44 tapers downwardly at its one edge 48 so as to snugly fit against the roof outer surface 17 and thereby present little resistance to the flow of air thereover. On the other three sides, there are a plurality of pedestals 49 provided with openings 51 therebetween for the flow of air therethough. The manner in which the condenser air flows through the console will now be described.

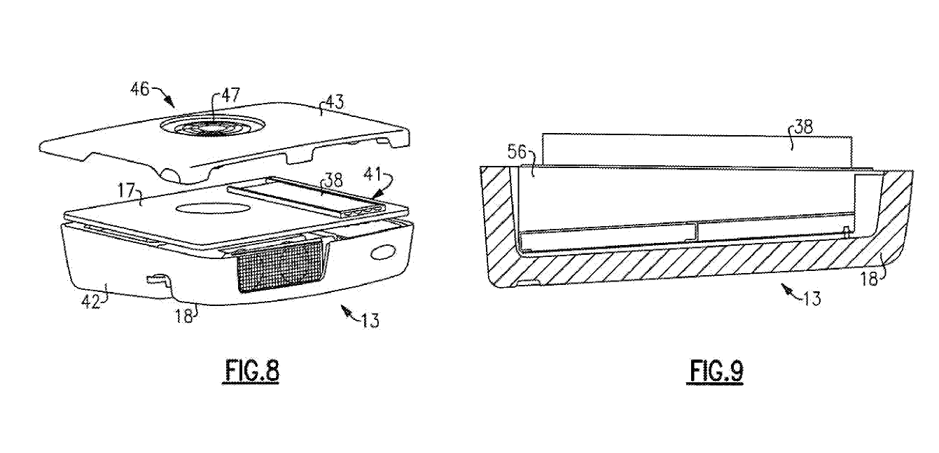

Referring now to FIG. 7, the vehicle insulated box 34 is shown with respect to the vehicle roof 52. A gasket 53 is disposed between the vehicle insulated box 34 and the internal surface 14. Further a gasket 54 is disposed between the housing 18 and the internal surface of the upper wall of the vehicle insulated box 34. With the condenser coil 38 in place in the opening 41 and the low profile platform 43 in place on the roof outer surface 17, the condenser fan 47 causes airflow through the system as shown by the arrows. That is, external air is drawn in through the openings 51, flows under the low profile platform 43 to the rectangular opening 44 where it passes through the condenser coil, through an internal space 56, and then upwardly through the circular opening 42 to ambient. This airflow pattern can be seen with respect to other views of the apparatus as shown in FIGS. 8 and 9.

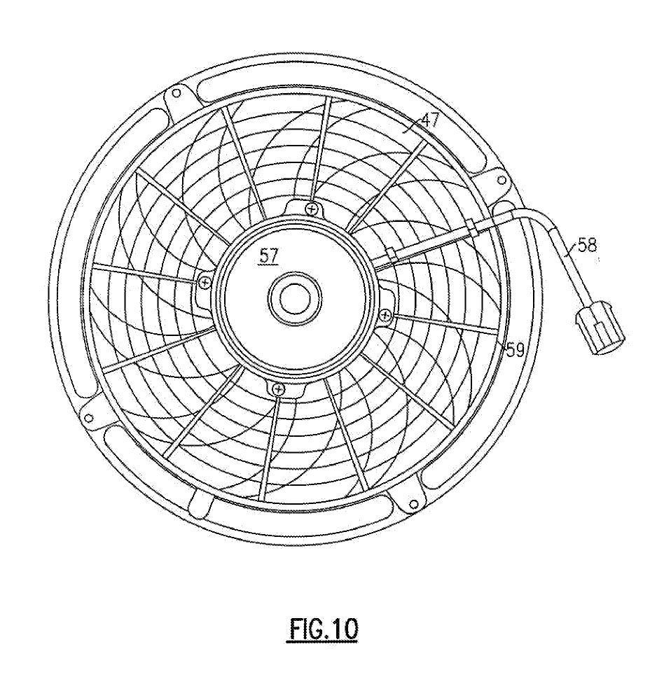

The condenser fan assembly is shown in FIG. 10 to include the condenser fan 47, a condenser fan motor 57 and its power cord 58, and a grill and support structure 59. It will be seen that the entire assembly takes up very little space, vertically, and therefore can be fit into the circular opening 42 with very little if any, of the assembly being above the upper surface of low profile platform 43. This is accomplished, in part, by the use of a flat brush motor for the condenser fan motor 57.

Although the present invention has been particularly shown and described with reference to a preferred embodiment as illustrated in the drawings, it will be understood by one skilled in the art that various changes in detail may be made thereto without departing from the spirit and scope of the invention as defined by the claims.

We claim:

1. A transport refrigeration console for installation in the roof of a vehicle, comprising:
an interior section, including a compressor and an evaporator coil, said interior section being adapted for mounting under the vehicle roof; and
a condenser section including a condenser coil and a motor driven fan, said condenser coil being located in a first opening in said roof and fluidly communicating with the ambient air above the roof and a space below the roof;
said motor driven fan being located above a second opening in the roof and operative to draw ambient air down through said first opening and said condenser coil, through said space and up through said second opening to ambient.

2. A transport refrigeration console as set forth in claim 1 and including a raised platform mounted above said roof and said first and second openings.

3. A transport refrigeration console as set forth in claim 2 wherein said raised platform includes a discharge opening formed therein and further wherein said motor driven fan is mounted in said opening discharge opening.

4. A transport refrigeration console as set forth in claim 1 wherein said motor is a flat brush motor.

5. A transport refrigeration console as set forth in claim 2 wherein the height of said raised platform is about 60 mm above the upper surface of the roof.

6. A transport refrigeration console as set forth in claim 2 wherein said raised platform includes a plurality of pedestals which engage the upper surface of the roof to thereby define a plurality of openings between the raised platform and the upper surface of the roof for the facilitation of airflow therethrough.

7. A transport refrigeration console as set forth in claim 1 wherein said first opening is rectangular in form.

8. A transport refrigeration console as set forth in claim 1 wherein said second opening is circular in form.

9. A transport refrigeration console as set forth in claim 1 wherein said interior section includes a housing with side edges which engage the bottom surface of the roof.

10. A transport refrigeration console as set forth in claim 9 wherein said interior section includes a fan and drive motor and further wherein said housing includes a return air opening and a supply air opening such that said evaporator fan causes air to flow in through the return air opening, through the evaporator coil and out the supply air opening.

11. A transport refrigeration console for installation in the roof of a vehicle comprising:
the housing having bottom and side walls with upper edges of said side walls being mounted adjacent an inner surface of the vehicle roof;
a compressor and electric drive motor mounted in said housing;
the evaporator coil, fan and drive motor mounted in said housing;
a return air opening and a supply air opening formed in said housing such that said evaporator fan causes air to be drawn from an interior space in the vehicle, pass through said evaporator coil and return to the vehicle interior by way of said supply air opening; and
a condenser coil and fan operatively connected in the console and fluidly communicating with ambient air.

12. A transport refrigeration console as set forth in claim 11 wherein said housing is composed of an insulating material.

13. A transport refrigeration console as set forth in claim 11 and including a gasket between said side wall upper edges and said vehicle roof inner surface.

14. A transport refrigeration console as set forth in claim 11 wherein said housing includes upstanding interior walls which define separate compressor and evaporator compartments.

15. A transport refrigeration console as set forth in claim 11 wherein said return air opening and supply air opening are formed in adjacent sides of said housing.

16. A transport refrigeration console as set forth in claim 11 wherein said compressor, evaporator and condenser are all fluidly connected in serial flow relationship.

17. A transport refrigeration console as set forth in claim 11 wherein a condenser coil is located in an opening in the vehicle roof.

18. A transport refrigeration console as set forth in claim 11 wherein said condenser fan is mounted above said roof.

19. A transport refrigeration console as set forth in claim 11 wherein said condenser fan is driven by a flat brush motor.

20. A transport refrigeration console as set forth in claim 11 wherein said condenser coil is mounted in an opening in the vehicle roof.
